(19) United States
(12) Patent Application Publication
(10) Pub. No.: US 2013/0339440 A1
(43) Pub. Date: Dec. 19, 2013

(54) CREATING, SHARING AND DISCOVERING DIGITAL MEMORIES

(71) Applicant: Be Labs, LLC, Seattle, WA (US)

(72) Inventors: Edward Balassanian, Seattle, WA (US); Damon Ganem, Seattle, WA (US)

(73) Assignee: Be Labs, LLC, Seattle, WA (US)

(21) Appl. No.: 13/852,755

(22) Filed: Mar. 28, 2013

Related U.S. Application Data
(60) Provisional application No. 61/616,783, filed on Mar. 28, 2012.

(51) Int. Cl. H04L 29/08

(52) U.S. Cl. CPC H04L 67/306
USPC 709/204

(57) ABSTRACT

An application may allow users to create digital memories, share memories with others, and discover memories of which they were a part. Digital memories may include or relate to pictures, videos, text, or audio captured through a mobile device at a specific location in the real world, in various embodiments. Memories may therefore be associated with other individuals present at that specific physical location at the same time. The application may thus relate to the intersections of people with places and other people, and may differ from other social networking applications in which interactions do not relate to people who are physically present at the same time. In various embodiments, media data and geolocation data may therefore be collected and used in association with the creation of digital memories.

### STATEMENT OF RELATED APPLICATIONS

The present application claims the benefit of and priority to copending provisional application no. 61/616,783 entitled Creating, Sharing and Discovering Digital Memories, filed on Mar. 28, 2012, in the name of Edward Balassanian. Such provisional application is hereby incorporated by reference in its entirety for all purposes.

The present inventive system and method relates to a web service for individuals to create digital memories comprising picture, video, text, audio captured through a mobile device at a specific location in the real world. Those memories may be associated with other individuals located at the same location and time.

### SUMMARY

The present invention relates to a mobile application that allows users to create digital memories, share memories with others, and discover memories of which they were a part. The mobile application, systems and interactions are herein referred to generally as “Timeline.” Timeline is focused on users in the physical world—e.g. not users in the online world. This has several implications:

1. Timeline is primarily a mobile experience—mobile phones are with users when they are moving about in the physical world. This is where they create memories and have real interactions with other people and places.
2. The timeline application doesn't create an alternate world—users do not create arbitrary lists of friends, nor do users create a personality independent of their real world personality. Timeline represents users in the real world and identifies users' natural connections with people and places.
Timeline is for users who, for example:
own smart phones
want to capture memories in a digital form (primarily in photos and videos).
   Users can create memories anywhere, for example:
in public
in private
in groups
   Users create memories when, for example:
they have their phones in their possession
they would naturally want to capture a memory utilizing one of, but not limited to, a camera, a video camera, a note taking device, or an audio capture device.
   Users utilize the Timeline application to (but not limited to)
share memories
revisit and resurface memories
capture memories
express themselves
leave behind (nostalgia)
   Timeline utilizes user generated memories to (but not limited to) :
generate intuitive intersections of people with places and other people
resurface memories based on people/place/time
   Differentiation with existing solutions:
existing social networking applications or websites (i.e. Facebook) allow users to create digital memories which involve people they don't interact with in the real world—e.g. people far away from them.
Timeline allows users to create digital memories which involve the people they interact with in the real world—e.g. people close to them.

### BRIEF DESCRIPTION OF THE DRAWINGS

A complete understanding of the present disclosed system and method may be obtained by reference to the accompanying drawings, when considered in conjunction with the subsequent, detailed description, in which:

FIG. 1 is an illustration describing a technique to associate one or more memories;

FIG. 2 is an illustration of an example mobile application interface showing a timeline of memories;

FIG. 3 is an illustration of an example mobile application interface to record a memory;

FIG. 4 is an illustration describing techniques to associate information with a given memory;

FIG. 5 is an illustration of an example mobile application interface to associate individuals with a given memory;

FIG. 6 is an illustration of an example mobile application interface to view individual associated with a given memory;

FIG. 7 is an illustration of an example mobile application interface to capture a note in association with a given memory;

FIG. 8 is an illustration describing techniques of displaying a virtual wall and associating individuals with the virtual wall;

FIG. 9 is an illustration of an example mobile application interface of a virtual wall;

FIG. 10 is an illustration of an example mobile application interface navigating a virtual wall;

FIG. 11 is an illustration of an example mobile application interface of individuals associated with a virtual wall;

FIG. 12 is an illustration of an example mobile application interface for viewing additional details about the individuals associated with a virtual wall;

FIG. 13 is an illustration of an example mobile application interface of a memory;

FIG. 14 is an illustration of an example mobile application interface for viewing additional details about the individuals associated with a virtual wall;

FIG. 15 is an illustration describing notification scenarios for individual users; and

FIG. 16 is an illustration describing intersections between one or more individuals and one or more memories.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in media environments of any type. Unless explicitly stated, the method embodiments described herein are not constrained to a particular order or sequence. Additionally, some of the described method embodiments or elements thereof can occur or be performed at the same point in time.

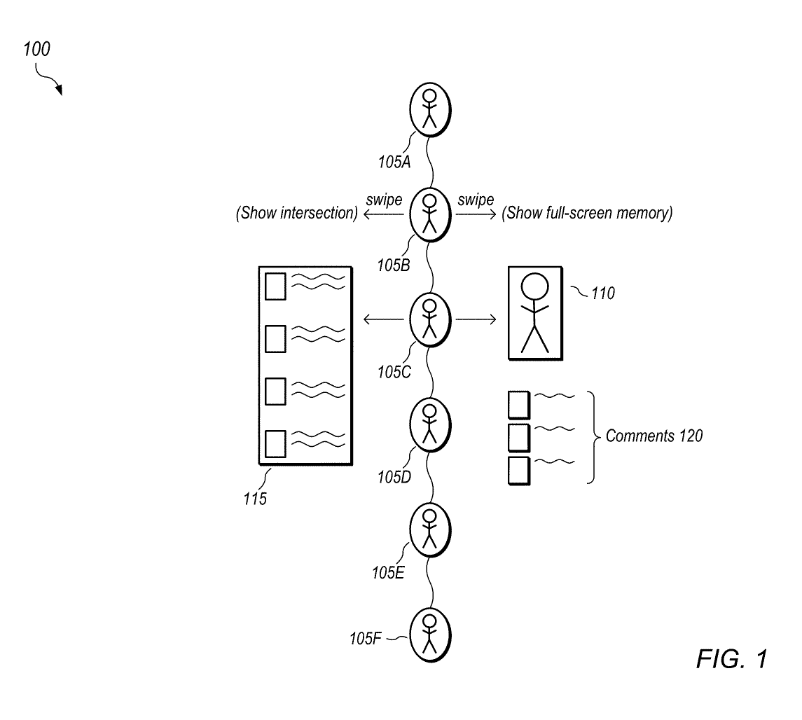

FIG. 1 shows a diagram 100 including representations of various memories 105A-105F. Memory representations 105A-105F may be a “Timeline”, or a chronologically displayed series of memories. With reference to memory representation 105A, a memory may be a picture, video, doodle, or audio note. With reference to memory representation 105B, a user may “swipe” the memory representation (e.g., to the left) to cause an “intersection” of the memory to be shown. The user may swipe a memory representation (e.g., to the right) to cause a full-screen memory representation to be shown (e.g., representation 110).

With reference to memory representation 105C, an intersection 115 for a memory may show a time-ordered sequence of memories posted by all the people who shared memories at a same place and time. With reference to memory representation 105D, other users tagged in a memory can make a comment 120 on that memory. With reference to memory representations 105E and 105F, memories may also include the time of day, the weather, and a place for the memory.

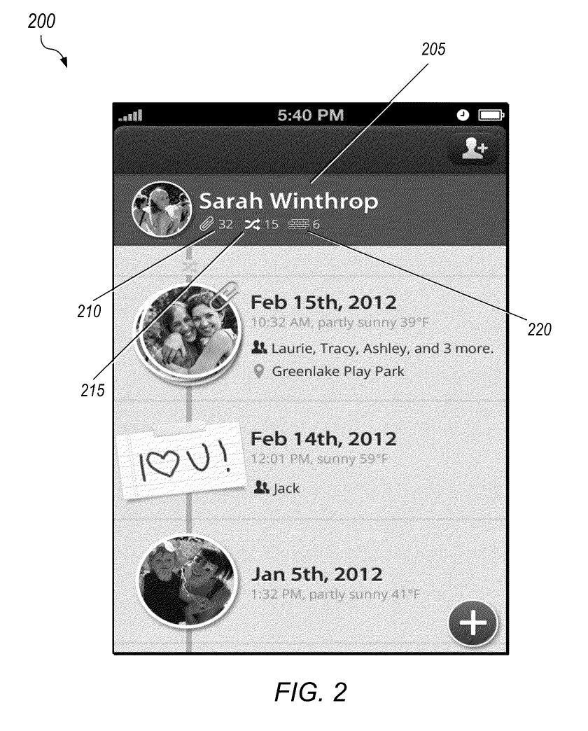

FIG. 2 shows a diagram 200 of an example mobile application interface showing a timeline of memories. In this diagram, a user “Sarah Winthrop” (205) has 32 memories (indicated by reference numeral 210). As indicated by reference numeral 215, user Sarah Winthrop has 15 memory “intersections” with one or more other users. Memories involving user Sara Winthrop may also be associated with 6 “walls” of users (as indicated by reference numeral 220).

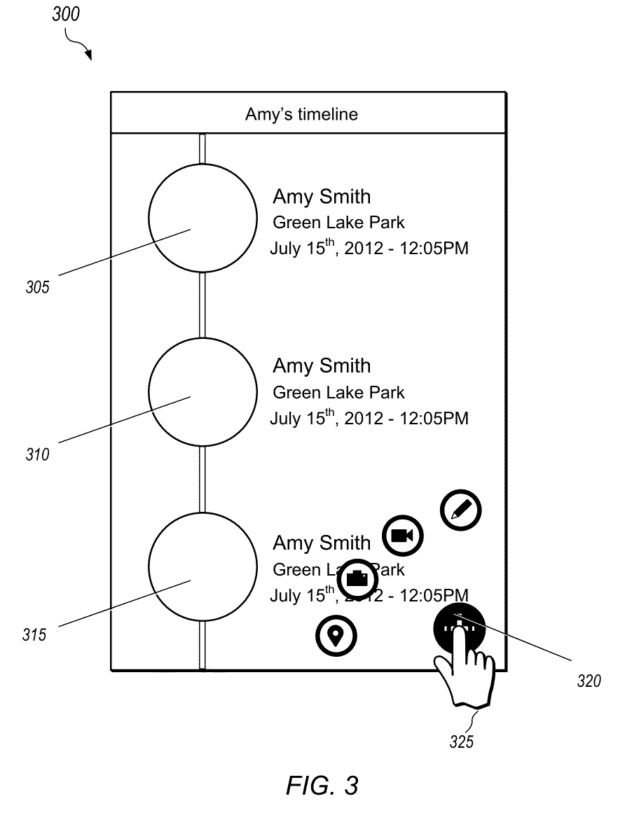

FIG. 3 shows a diagram 300 of an example mobile application interface usable to record a memory. In this figure, the mobile display includes memory representations 305, 310, and 315. A “+” (plus) icon 320 is selectable by a pointer 325 in order to allow a user to manually add a tag. The user can set which side (e.g., left or right) of a memory on which the plus icon shows up.

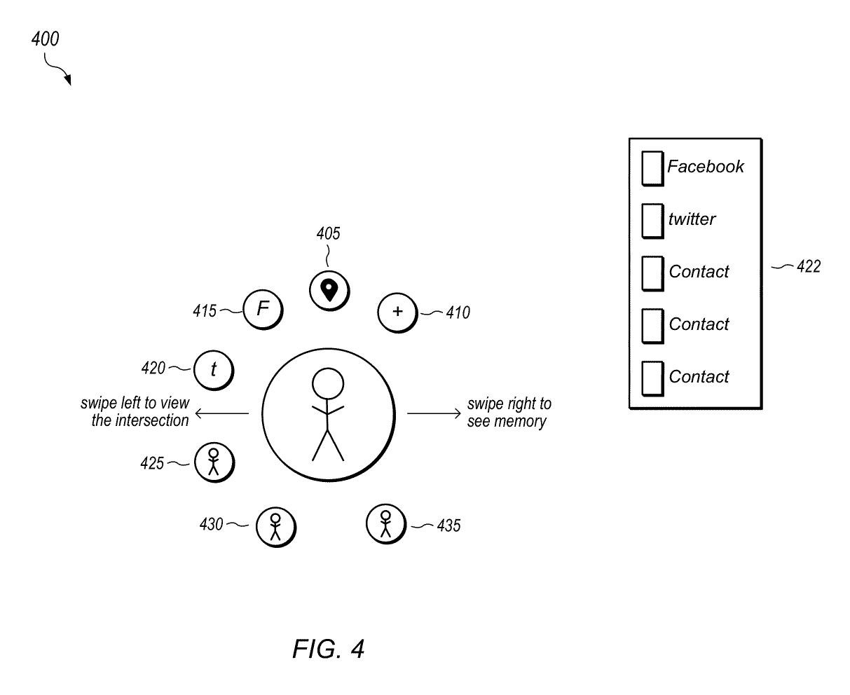

FIG. 4 shows a diagram 400 in which information may be associated with a given memory. In the embodiment of FIG. 4, each memory may be associated with a place. A place marker 405 allows a user to select a place. Popular neighborhoods may be shown from which a user can select. A user can also choose his or her own (custom) name for a place. When a user names a place, people the user shares the memory with may see the name as a choice when they create their own memories at the same place. This way a user can allow a private name where other people you share memories with to use the same private name. Memories created at same GPS coordinates with a different place name are not considered shared or intersected, in the embodiment of FIG. 4. Note that if a user is near a public wall, the wall name will show up on the system for the place name, in the embodiment of FIG. 4.

A user can also add tags in the embodiment of FIG. 4 by clicking on the “+” icon 410. For example, the add tag may connect a user with his or her FACEBOOK and TWITTER accounts (e.g., via icons 415 and 420) as well as address book contacts (e.g., contained in the display element indicated by reference numeral 422). The first time a user clicks on FACEBOOK or TWITTER, the user will be presented with a link to connect the respective sessions, in the embodiment of FIG. 4, which will only be needed once. Additional icons 425, 430, and 435 may respectively be associated someone a user has previously tagged, someone nearby who has tagged the user, and someone in the user's contacts who is nearby. In the embodiment of FIG. 4, only people who the user tags will share their memories. Tagged other users can view a memory by sliding to the intersection of the user's memory along anyone else who has shared memories at the same place and time. If a user does not tag anyone in a memory then it is seen as private.

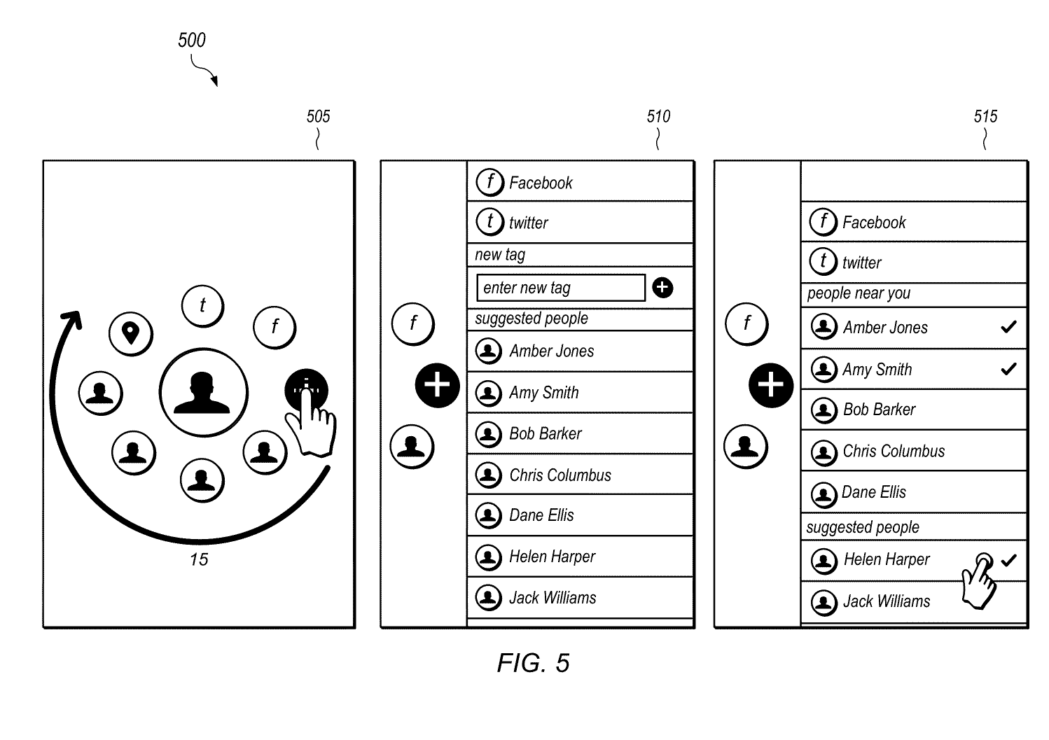

FIG. 5 shows a diagram 500 of an example mobile application interface usable to associate individuals with a given memory (e.g., tag those individuals). Display elements 505, 510, and 515 relate to various aspects of tagging individuals in the embodiment shown.

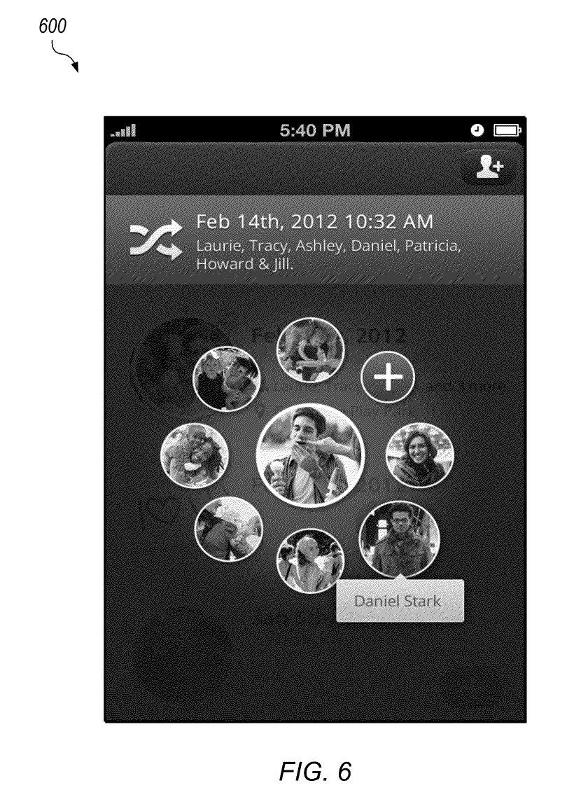

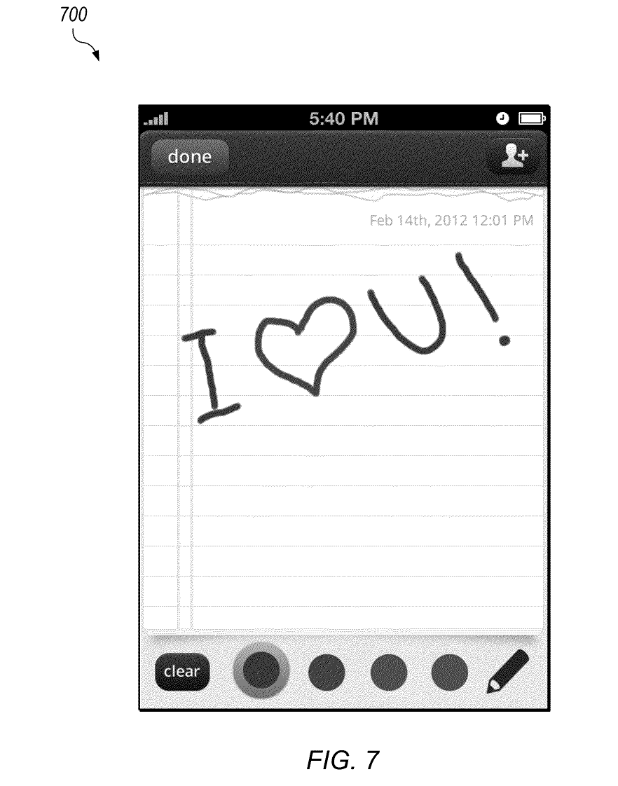

FIG. 6 shows a diagram 600 of an example mobile application interface usable to view an individual associated with a given memory. FIG. 7 shows a diagram 700 of an example mobile application interface usable to capture a note in association with a given memory. In this embodiment, the note is a sketch reading “I (HEART) YOU”.

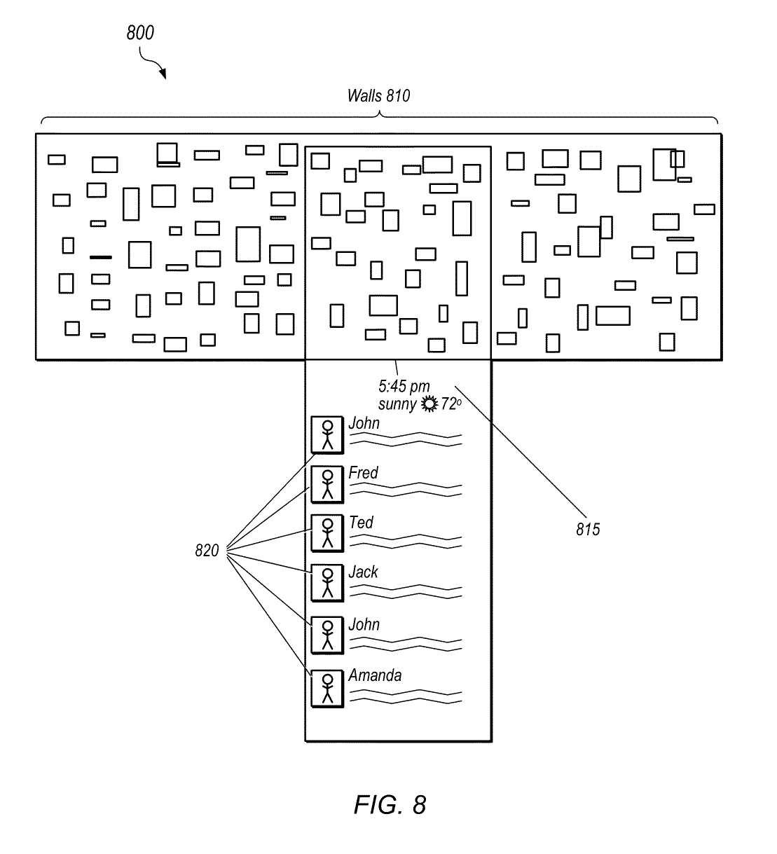

FIG. 8 shows a diagram 800 relating to aspects of displaying a virtual wall and associating individuals with the virtual wall. In the embodiment of FIG. 8, walls 810 are, by definition, public. Any memories posted on a wall are publicly viewable in this embodiment. An intersection of walls is defined by a time at which posts were made grouped together in this embodiment. Further, in this embodiment, anyone can post at a wall and walls may be created in advance by Timeline and public groups. In the embodiment of FIG. 8, individual memories 820 are posted, and a particular time and/or weather condition 815 may be representative of an intersection of memories.

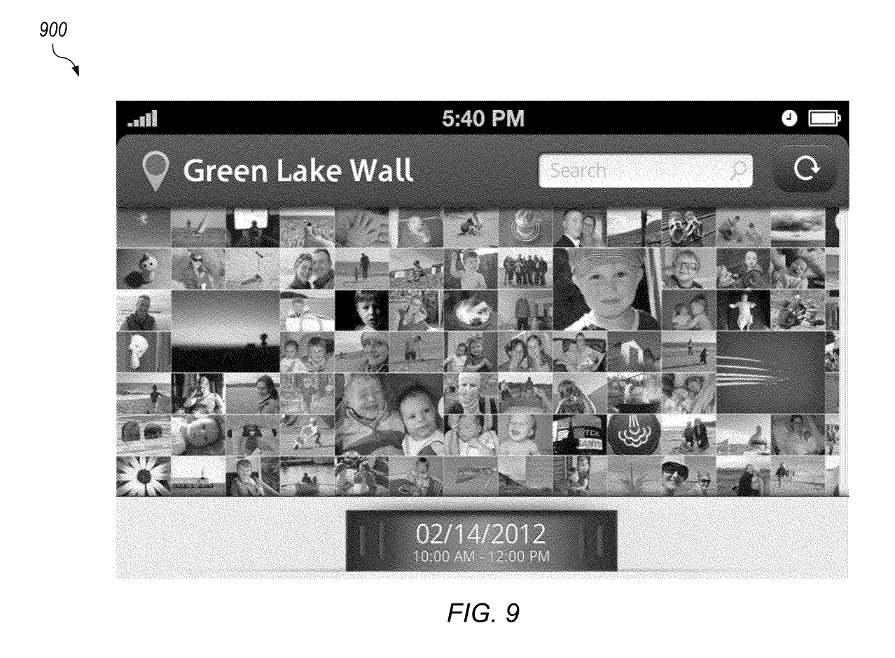

FIG. 9 shows a diagram 900 of an example mobile application interface usable to display a virtual wall.

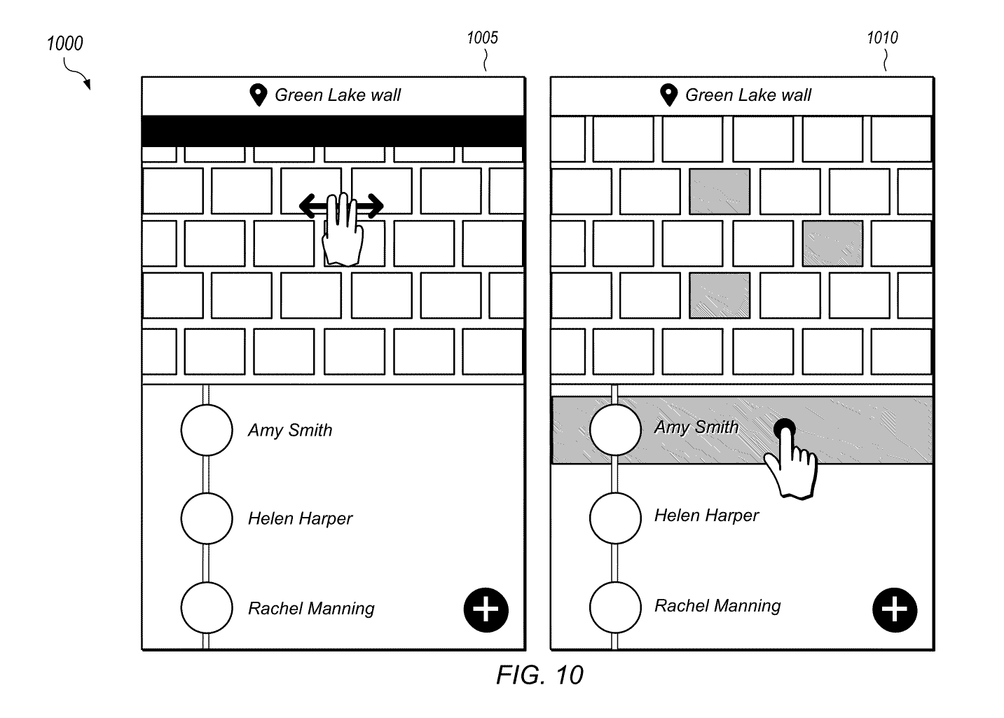

FIG. 10 shows a diagram 1000 of an example mobile application interface usable to navigate a virtual wall. Display elements 1005 and 1010 relate to various aspects of navigation in the embodiment shown.

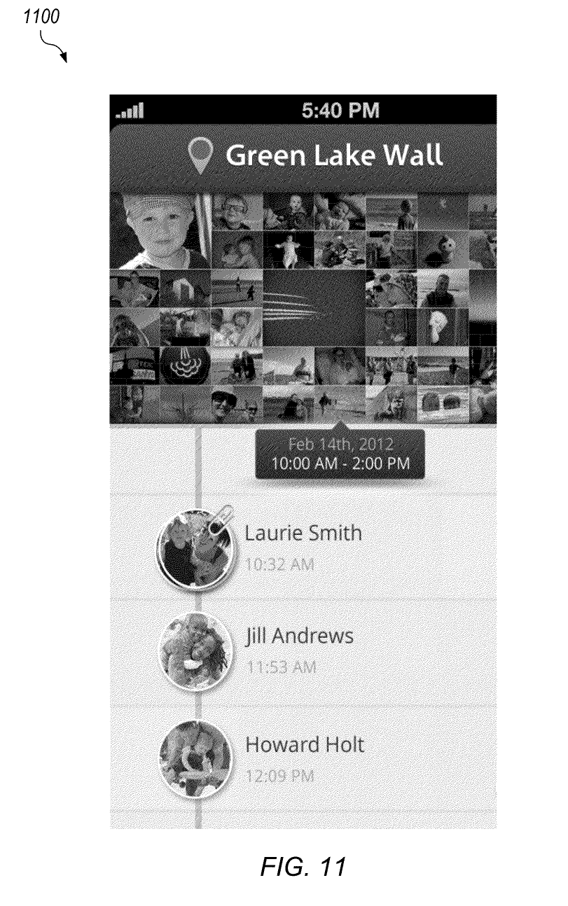

FIG. 11 shows a diagram 1100 of an example mobile application interface usable to display individuals associated with a virtual wall.

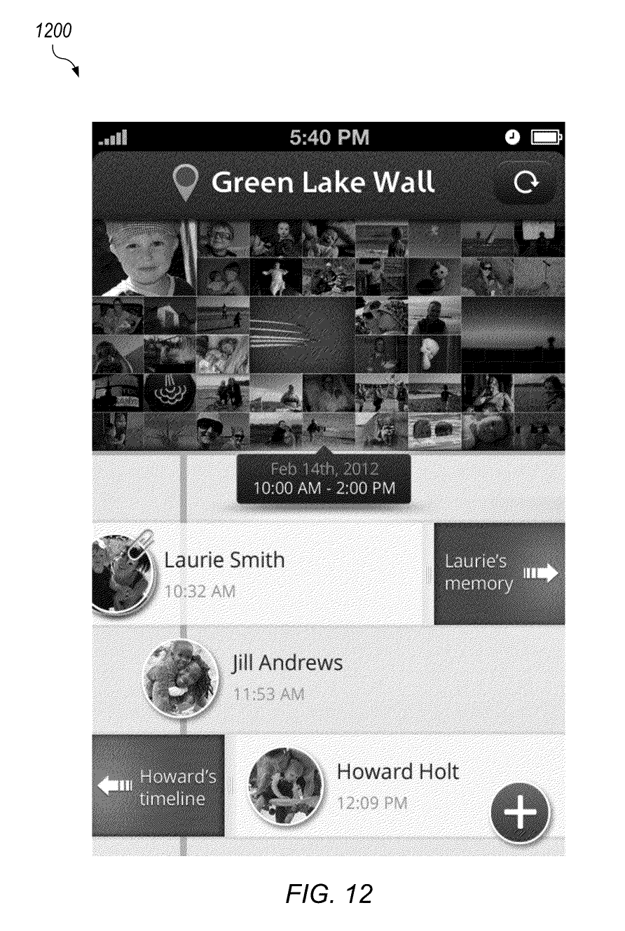

FIG. 12 shows a diagram 1200 of an example mobile application interface usable to view additional details about individuals associated with a virtual wall.

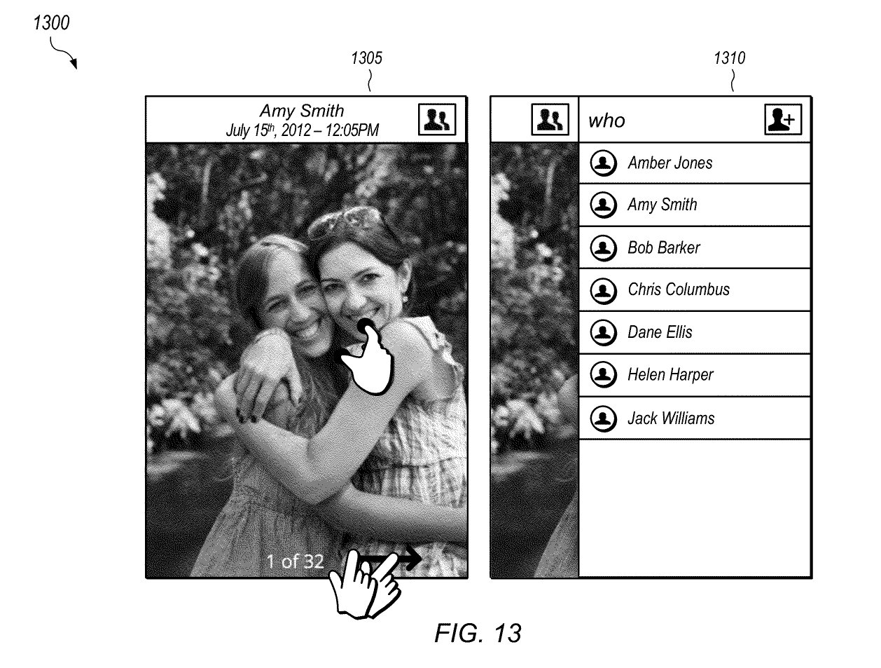

FIG. 13 shows a diagram 1300 of an example mobile application interface displaying a memory. Display elements 1305 and 1310 relate to various aspects of displaying a memory in the embodiment shown.

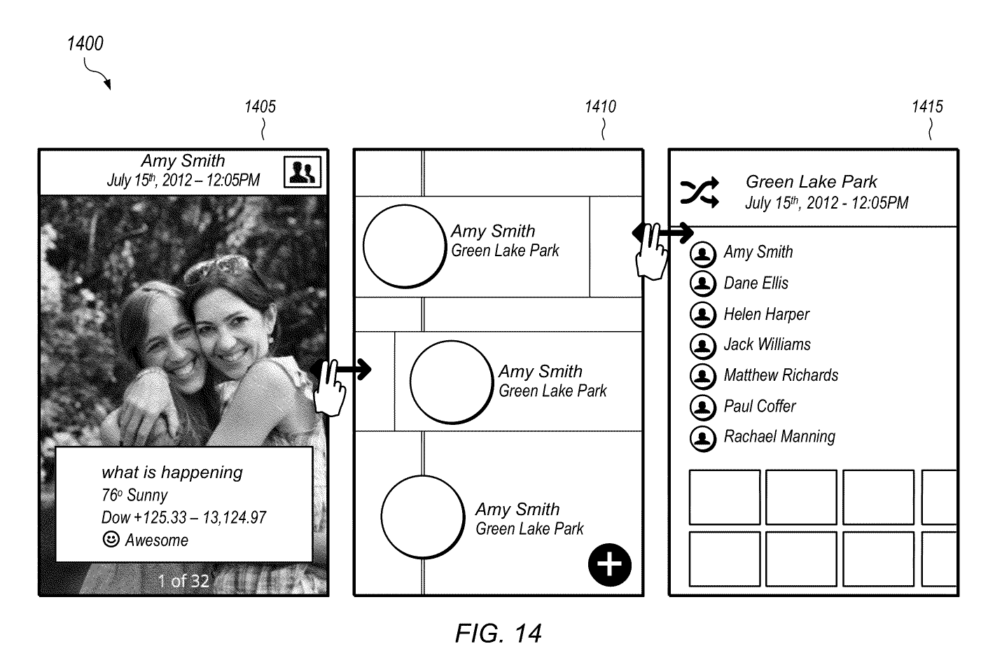

FIG. 14 shows a diagram 1400 of an example mobile application interface usable to view additional details about individuals associated with a virtual wall. Display elements 1405, 1410, and 1415 respectively relate to aspects usable to view additional details relating to a memory, a timeline, and an intersection.

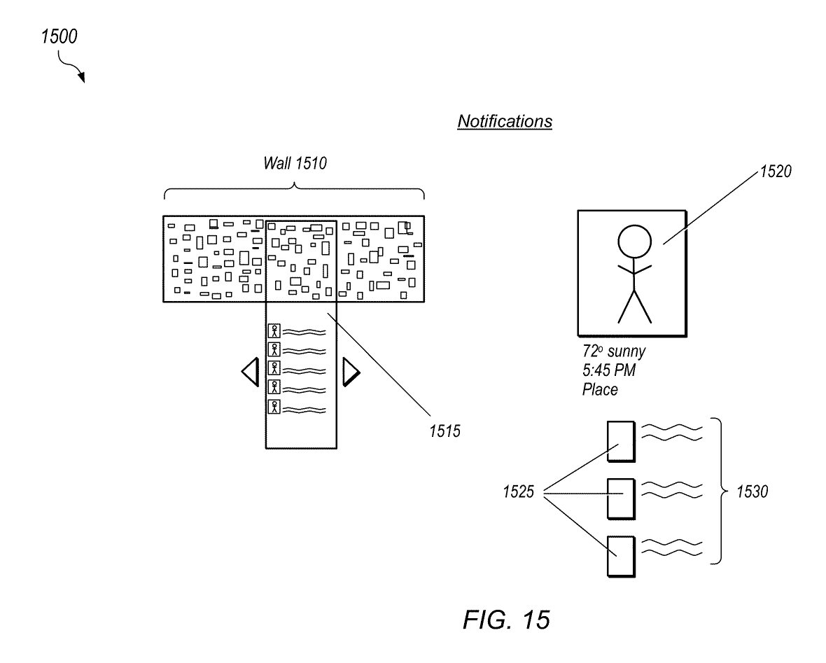

FIG. 15 shows a diagram 1500 of an example mobile application interface displaying notification scenarios for individual users. In this embodiment, near a wall 1510, clicking a notification takes a user to the wall. From the wall, a user can scroll through memories (e.g., using scroller element 1515). Clicking on a memory can cause the display to jump to that memory (e.g., as shown by display element 1520). A user may receive a notification that he or she has been tagged in a memory. A user may receive a notification that a comment was made on a memory he or she was tagged in. Clicking on a memory may take the user directly to a comment in this embodiment. A user may also receive a notification that a memory has been resurfaced. In the embodiment of FIG. 15, user avatars 1525 and comments by individuals 1530 may also be displayed.

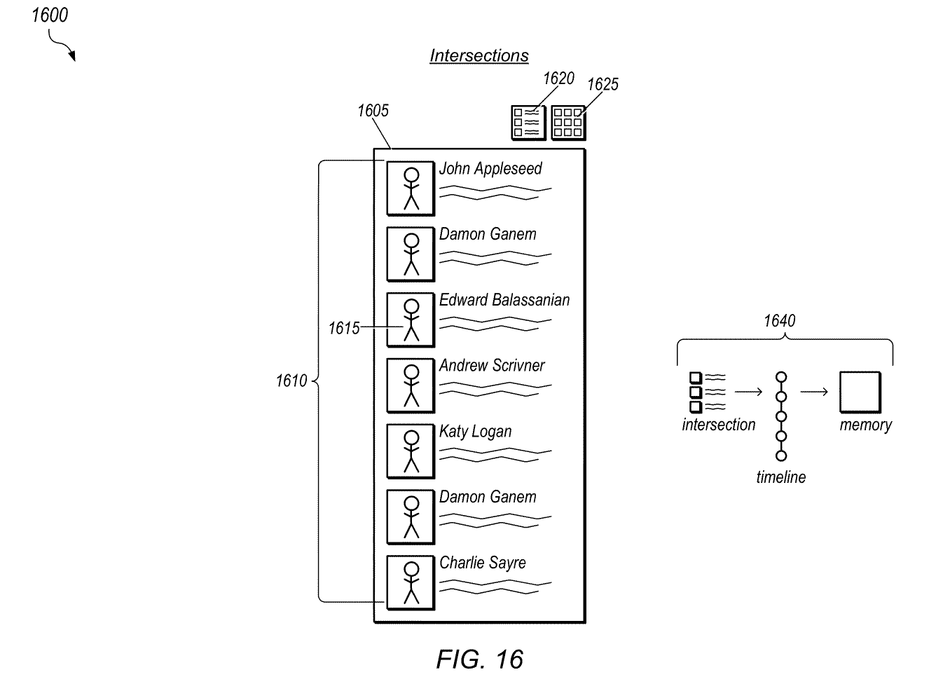

FIG. 16 shows a diagram 1600 of an example mobile application interface displaying intersections between one or more individuals and one or more memories. In this embodiment, an intersection 1605 represents a time ordered series of shared memories 1610. Each one of memories 1610 includes the person's name, the time the memory was created, and the comments associated with the memory, as shown. A thumbnail 1615 of one memory is also shown. Elements 1620 and 1625 may be selected to cause display of memories in list mode or gallery mode, respectively. Selecting a memory will take you to the timeline of the person who created it, in this embodiment. Further, in the embodiment of FIG. 16, shared memories occur when people create memories at the same place and time. This is also the case if a user is tagged in someone's memory and has created a memory at the same place. A public wall also creates intersections of all the people who created and posted memories on the wall, in this embodiment. Elements 1640 also show a relationship between an intersection, timeline, and a memory, in the embodiment of FIG. 16.

When the user installs the mobile application, Timeline can ask them to identify themselves by showing them a drop down list of contacts in their phone or other mobile device. If the software operating on the phone enables it, Timeline may attempt to select their contact. If it is not enabled, then Timeline may auto-complete as the user types in their name. The user can authorize their contact information to be sent to Timeline servers (herein also referred to has “system”) so Timeline can associate their name, number, and email addresses with future interactions with other users. Since timeline can resurface memories based on significant dates, Timeline may also ask them for dates of significance. This may be presented as a drop down list of dates. Once checked, timeline may resurface memories. Example significant dates can include, but are not limited to;
birthday (checking this may show a date input field)
anniversary (checking this may show a date input field)
holidays

Next, the process may begin to automatically populate the user's timeline—Timeline may attempt to find memories with which a user has already been associated by another user. This can be done a variety of ways. For example:
photo library scanning—scan the user's photo album and identify photos that were taken at the same time and place as other Timeline users.
show a list of possible intersections to the user based on the photo-library scan. Separate the list into people from the user's address book and those who are not.
use photo recognition to identify people in photos as possible tags.

Next, the user may be presented with a timeline of memories each with the burst of potential people to tag in the memory. Bursts are described in detail below. Each memory remains private until the user clicks on the people being suggested for tags. The user can also create a list of “always allow” tags that are automatically tagged.

A user's profile is created in parallel to their experiences in the timeline application. When they share via Facebook and Twitter, they may be asked if they want to Facebook connect. Timeline can then leverage their contacts on Facebook. For purposes of relevance, Facebook contacts are no more relevant than address book contacts.

In the final step of the startup experience, the user may be asked if they want to invite other users they have shared memories with in the past. This is not the same as gratuitously inviting “friends” to join. Rather, when a user sends an invitation to other individuals to join, they install the application, and when Timeline scans their memories (e.g. photos in their library), they add tags that potentially include the requesting user. This is a powerful feedback loop.

### Application Startup

After initial setup, the mobile application can perform the following steps when launched on the user's mobile device including but not limited to:
download latest list of walls
download latest list of memorable places for the user (this is useful in case the application is reset and loses this data locally)
scan the photo stream to identify any new photos that were not taken in the app—this will trigger notifications suggesting to the user that they can add the memories and tag them.
   The above features are described in detail below.

### Memories

The types of memories that can be captured by Timeline include, but are not limited to:
photos
videos
notes—notes are distinguished from comments since notes can be drawn by hand.
All memories can have a comment associated with them.

For purposes of illustration, refer to FIGS. 1, 2, 3, 7, 8, 9, 10, 11 12, 13 and 14.

### Resurfacing Memories

Timeline intelligently resurfaces memories based on location, time, and proximity to places and people.
memories may be resurfaced when a user is at a location they previously created a memory in.
memories may be resurfaced when a user is at a location where a memory was created in which they were tagged in (e.g. Damon creates a memory in Times Square and tags his young son Liam. 20 years later, Liam will see the memory if he is in Times Square)

### Resurfacing Rules

the first time a user revisits a place they created the memory
the first time a user who was tagged in a memory revisits the place where the memory was created
the first time a user revisits a person they shared a memory with (e.g. they tagged a user or another user tagged them)
the anniversary of a memory

### Previews

Photo and video posts can be created with a preview so they can be viewed immediately. Previews contain thumbnails and low-res (or progressive) images for photos, and sequential stillframes for videos. The hi-res photos and videos are sent up asynchronously in the background. The user may be asked if they want to allow uploading of the memories via 3G or only wireless.

Generating previews also helps with extracting frames from videos that may be used for photo recognition. The system may pullout frames, find faces within the frames, then leverage the crowd sourced tagging of people to build a database of facial patterns. This will help with identifying people and places within photos and videos.

### Locations

When a user creates a memory, the memory is tagged with the location. The user has the option of naming the location. Other users can see the name of the location. Additionally, the system can be configured such that the unique name given is only visible to users who have been tagged in the memory.
The following information can be associated with each memory at the time it is created, but memories are not limited to association with:
The current weather
The neighborhood
Walls

### Intersections

An intersection is quite simply a shared memory.

Intersections are sometimes implicit (e.g. two people in the same photo) or explicit (e.g. User A tags User B in a memory so User B may see it). In general the following types of intersections will occur:
with other people at the same place
with other people in the memory (e.g. in a picture)
with other people
   It is understood that many types of intersections can be created, and not limited to the above.

Intersections can also occur at walls. An intersection is defined as a point in time that aggregates the posts from all people on the wall at that moment. The system can be configurable to define what constitutes a moment in regards to a wall. For example: number of people, a specific event, a specific time, or any other unique identifying attribute. For purposes of illustration, refer to FIGS. 8, 10, 11, 12, 14 and 16.

Once a memory is created, the mobile application may immediately send a preview of the memory to the system. This may be used to generate the thumbnail for representation in the timeline as well as a low-res rendition of the memory. The full-res version of the memory can be uploaded in the background. Background uploading will enhance by:
smarts to not drain the battery—for example, only uploading when the app is in the foreground
smart to not abuse data plans—for example, only uploading over wifi
smart to upload a preview quickly so previews are synchronously created. For example, in many public venues such as stadiums, bandwidth is extremely constrained making it difficult to upload more than a few KB of data at a time.

### Tagging

Tagging is a way of explicitly intersecting a user's memory with other people. When a user tags someone, the tagged user will receive an application notification. After the notification, the user can then accept the tag or remove it. If they accept the tag, they will see the memory in their ‘feed’.

Users can manually add tags by clicking on the “+” next to a memory. This may pull up their contact list which may include Facebook, Twitter, and their address book contacts. Tagging Facebook and Twitter will allow the user to post a memory to Facebook or Twitter directly.

If a user tags someone from their contacts who is not a user on Timeline, then their contact info is associated with the tag. Where possible Timeline will send a text message from the capturing user's device to the new user inviting them to join

Timeline to view the memory in which they were tagged. The text message can include a link to the mobile application or to a website. Once the new user installs the application and enters their contact information, the tag is automatically matched to their contact info.

Smart tagging refers to the application automatically suggesting possible tags to the user. This includes:
proximity based suggestions—show people around the user at the time they create their memory. Timeline may default to people in their contacts or anyone who is on the site.
previous tag suggestions—people a user has frequently tagged in the past should be shown as tag options.
photo recognition—Timeline can use facial recognition to determine who might be in a memory.

### Crowd Sourced Photo Recognition

as users are tagged in photos, the system may leverage the multiple photos to narrow down the users, then learn those users faces from multiple angles to improve the photo recognition.
the system can be configured to automatically identify users when a memories have an associated video recording, through the use of facial recognition.
the system can be configured to automatically identify users when memories have an associated audio recording, through the use of voice identification.
   For purposes of illustration, refer to FIGS. 3, 4, 5, and 6.

### Notifications

A user can be notified when they are tagged in a memory. The mobile application is configurable to include in-app notifications. Notification can allow a user to view the memory that was created and that the user was associated with. Further, the user can comment on a memory. New comments on memories in which the user was tagged generate new notifications.

The following is a list of notifications. It is understood that additional notifications can be added to the system:
user is near a wall
user is near a previous memory (either one the user was tagged in or one the user created)
user is close to someone they have previously shared a memory with
user has been tagged in a memory
a comment was made on a memory the user was tagged in \
a relevant date has come up (e.g. it's the user's birthday or the user asked to be reminded about a memory at a time in the future).
   Other notification options can include, but are not limited to:
Notify a user when a memory they created has been visited by another user.
   For purposes of illustration, refer to FIGS. 15.

### Notification List

A section of the user interface can allow the user to see a list of incoming notifications that need to be acted on in a time independent manner. These can include tag requests, comment notifications, and photo scans.

### Walls

Walls are a vehicle for sharing memories publicly. A wall represents the confluence of people and places at a particular location. Posting on a wall is a way of publicly capturing a memory. Users can tag people in the memory and that memory may then be resurfaced when they are in that location at a future point in time.

Since walls are public, anyone can post on a memory they see on a wall. Commenting on a wall memory adds the user to the notification list for the memory. Any future comments on the memory may trigger a notification to the commenting user. The originator of the memory is also notified on any comments on a wall memory. Memories posted on walls can also include tags. Other users tagged in a wall memory may be notified of the tag.

For purposes of illustration, refer to FIGS. 8, 9, 10, 11 and 12.

### Wall Games

The system can incorporate game dynamics into the wall in a way that leverages the public aspect of walls. Some examples are, but are not limited to:
give badges to people who frequent a wall the most
hide treasures related to local retail venues in the wall
incorporate trivia into the wall so when a user posts on the wall they are told a fact about the wall venue
add fortune cookies to the wall so when a user posts they receive a fortune that is appropriate to the venue.

### Timelines

Every user has a timeline that represents the memories they have created and their intersections. The timeline is shown in time order. Users can filter their timeline to include specific memories (either their own or those they have been intersected in). For purposes of illustration, refer to FIGS. 1, 2, 3, 11, 12 and 14.

Each node in the timeline can be configured to respond to specific gestures via a touchscreen interface that shows the people the memory was intersected with. These intersections can be explicit (the user added them when the memory was created), or implicit (they happened at the same time as others).

When a user swipes from a memory, they can see the intersection of that memory with other memories that were created at the same place and time. Swiping is the gesture of selecting a specific memory and either moving left or right to see additional information. The system may be configurable to enable swiping in any direction to load different information. This can be on a public wall or in a private group. Timeline shows the user the memories of people around them who tagged them in memories or that they tagged in memories at the same time. For purposes of illustration, refer to FIGS. 12, 13, and 14.

### Intersecting Timelines

A user can view an intersection of multiple timelines. This shows a user a history of the memories that were shared between them and the other timelines they select. This may be accomplished by allowing a user to select people from a dropdown list that have shared memories with them. By default a user's timeline shows all their memories—both the ones they have created and the ones they have shared. They can turn on/off individual people from the timeline to only see the memories of specific people or they can filter to just themselves. For purposes of illustration, refer to FIGS. 8, 10, 11, 12, 14 and 16.

### Profiles

People are not the emphasis in Timeline, memories are. When you install the application, we will ask you about your name, relevant dates such as your birthday, anniversary, etc . . . These are for the purposes of reminding you to make a memory. We do not ask you to tell us where you live, how old you are, what your bio is, where you worked etc . . . Similarly we do not think it is useful for profile pages to make this type of information available to other users. The people you interact with in Timeline are people you interact with in the real world.

### Privacy

By default, all memories are private. There is no implicit sharing of memories. This ensures that users never have a surprise. In addition, a user can only tag memories that they create. Further, one user cannot ‘share’ another user's memory with other people. This prevents the common social networking problem of a photo unexpectedly going public, even though it was shared privately.

The Timeline application encourages sharing by facilitating intuitive tagging. Timeline suggests people to tag that would intuitively make sense to share a memory with. If you do not tag people in a memory, the memory will remain private.

For purposes of illustration, refer to FIGS. 3, 4, 5, and 6.

### User Options

Below are user options within the Timeline application. It is understood that additional options, a reduced number of options, no options or a combination thereof can be utilized by anyone of the user, application or system. Such options can include:
location lookup—this enables the app to lookup information related to the location where a memory was created. Further, Timeline can have various parameters incorporated into this, including but not limited to:
   location
   time of the day
   weather
   stock market price
   mood (e. g. let the user pick a mood)
   phase of the moon
   current president
   interest rate
   headline news of the day
notifications on/off
   wall notifications
   memory resurfacing
   comments
   tags
proximity detection
   other users—e.g. we can keep track of other users who are nearby the user when they create a memory. This would be independent of who the user tags in a memory.
memory upload
   wifi only—send memories to the server over wifi only
low battery
   disable app at certain battery percentage
connect to fitness apps (e.g. Nike running)

Information the Timeline system collects can be used to provide the user with insight into their lifestyles and how they related to their overall happiness. For example, Timeline can provide simple analytics that show the user trends, such as:
who they are around when they have happy memories
what time of day they generally have the happiest memories
what the phase of the moon is when they are happiest
heat map of locations they are the happiest at
heat map of the weather patterns they are the happiest at

Essentially Timeline can determine the correlation between the data it collects in order to help the user understand themselves better.

The invention is:

1. A system for capturing and resurfacing memories, comprising:
on a mobile device having at least a multimedia image capturing device, a location detection mechanism, and an execution mechanism, a timeline application including:
a memory capturing component configured to capture a multimedia image, to associate a time value and geo tag with the multimedia image, and to transmit the multimedia image to a remote timeline server for storage in association with a user account;
a memory resurfacing component configured to determine, from the mobile device, a current location of the mobile device from the location detection mechanism, to query the remote timeline server for stored multimedia images associated with the current location, and to prompt the user with a retrieved multimedia image, the retrieved multimedia image having a geo tag related to the current location, prompting the user including identifying the time associated with the retrieved multimedia image; and
a social interaction component configured to enable providing and reviewing comments about the retrieved multimedia image.

2. The system recited in claim 1, further comprising a user selection component configured to allow selection of other users so that memories captured by the other users may be viewed on a timeline associated with the user account.
